(19) United States
(12) Patent Application Publication
(10) Pub. No.: US 2006/0082740 A1
(43) Pub. Date: Apr. 20, 2006

(54) Auto adjustment video projector (AAVP)

(76) Inventor: Ridha Radhouane, Sunnyvale, CA (US)

Correspondence Address: RIDHA RADHOUANE, 850 SOMERSET DRIVE, SUNNYVALE, CA, 94087, US

(21) Appl. No.: 11/073,359

(22) Filed: Mar. 7, 2005

Related U.S. Application Data
(63) Continuation of application No. 09/668,864, filed on Sep. 25, 2000, now abandoned.
(60) Provisional application No. 60/158,060, filed on Oct. 7, 1999.

(51) Int. Cl. G03B 21/00

(52) U.S. Cl. 353/122

(57) ABSTRACT

A video projector equipped with a sensor assembly made of video cameras and with a processor. The sensor assembly allows capturing the projection surface. The processor analyses the video frames from the sensor assembly in order to compute and update automatically the optimum projection parameters. The video projector will set automatically the Focus, the Brightness, the Contrast and the Color Saturation of the projection, depending on the room lighting, the projection distance and the quality of the projection screen.

### CROSS-REFERENCES TO RELATED APPLICATIONS

This application claims the benefits of provisional patent application No. 60/158,060, filed Oct. 7, 1999 entitled “Picture to Picture Pointer, White Shadow and Auto Adjustment Projector”.

### STATEMENT REGARDING FEDERALLY SPONSORED RESEARCH OR DEVELOPMENT

“Not applicable”

### REFERENCE TO A MICROFICHE APPENDIX

“Not applicable”

### BACKGROUND OF THE INVENTION

1- Field of the Invention

The present invention relates to video projector technologies

2- Description of the Related Art

Before using a video projector, it is necessary to set its focus, lightness, contrast and color saturation. These settings are made easy when the projection room and screen are designed adequatly. When the video projector and the screen are fixed, these adjustments are usually made one (at the installation). With portable video projectors, projection conditions (room darkness, quality of the projection screen, projection distance, . . . ) may vary from a presentation to an other. The user has to adjust his device (the projector) in order to optimize the projection quality: he has to set the focus according to the available projection distance and the screen size and he has to adjust the brightness, the contrast and the color saturation depending on the projection room and screen.

The disadvantage of portable video projectors is the necessity of the setting phase prior to every new projection, when the projection conditions ere changed.

### BRIEF SUMMARY OF THE INVENTION

The principal of this invention is to make the video projector adjustments (focus, brightness, contrast and color saturation) automated. The video projector will be able to detect the projection conditions (distance to the screen, screen quality, room darkness, . . . ) and to set the optimal setting parameters in order to allow the best quality of projection in those conditions.

The projection conditions will be quantified by the mean of a detecting device (CCD camera for example) integrated to the video projector.

### BRIEF DESCRIPTION OF DRAWINGS

FIG. 1 illustrates the principle of the Auto Adjustment Video Projector: a capture device (CCD camera) allows to read the projection screen conditions in order to set automatically the projector.

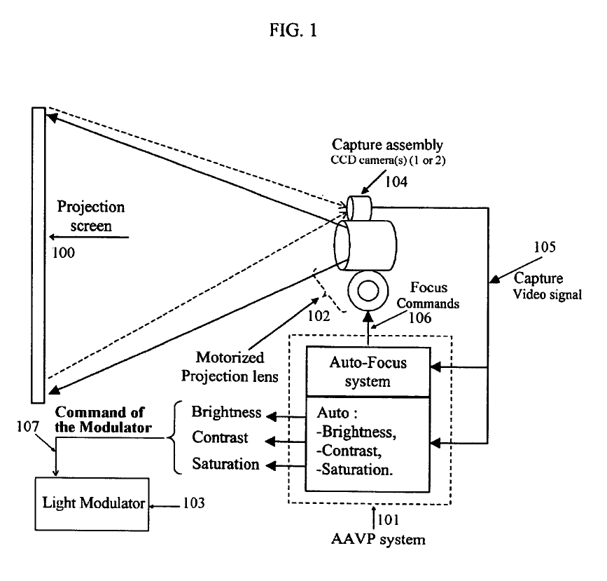

### DETAILED DESCRIPTION OF THE INVENTION

Video projector will be equipped with a video camera that shoots back the projection screen (during an initialization phase). The video image of the screen will be interpreted to extract the informations describing the screen conditions, the projection distance and the room conditions (darkness and noise light). These condition informations will be used to set the different adjustment parameters (focus, brightness, contrast and color saturation):

Auto Focus:

In addition to the capture system (CCD video camera), the video projector will be equipped by a motorized projection lens. The auto focus system (Hardware system integrated to the video projector) controls the motorized projection lens in order to obtain the best possible setting. A feed back loop composed by the capture device (CCD camera), the auto focus Hardware and the motorized projection lens operates to converge to the optimal focus value.

The projector sends to the projection screen a sequence of test signal (lines, circles, or others . . . ). The capture device (CCD camera) reads back these test signals and sends their video signal to the auto focus system to process them and command the motorized projection lens accordingly. The best focus setting is obtained when the projected image (of test signals) is closer to the received screen (received by the capture device: CCD camera).

Auto Brightness:

The capture device in the video projector scans the projection screen and analyses its reflection characteristics in order to set the right brightness. Also the ambient noise light (the room light) is measured and involved in the computation of the brightness parameters. The control of the brightness can be made pixel by pixel. Psycho visual considerations are involved in the amlgorithm.

Auto Contrast:

The captured screen informations are used to determine the optimum contrast value to apply so that the viewers get the finest quality of projection for any particular conditions. The control of the contrast can be made pixel by pixel.

Auto Color Saturation:

The projection screen may not be always perfectly neutral: some parasite colored reflections (colored windows or door glass, reflection on colored wall . . . ) can give the screen a tint of some color. The presentation will be affected and the screen stain will distress the audience. Although the human eyes restore this effect (after the beginning of the presentation), it still worthwile to recover the screen from the video projector by neutralizing the noise lights on it. This will release the viewer eyes and make them more comfortable. The control of the color saturation is made pixel by pixel.

What is claimed is:

1-7. (canceled)

8-16. (canceled)

17. A method for automating the Focus, Brightness, Contrast and Color Saturation of a video projector, comprising the steps of:
a) Projecting a video frame on a projection screen 100;
b) Capturing the said projection screen with a capture assembly 104;
c) Analyzing the video frame of the capture video signal 105;
d) Computing new settings of Focus, Brightness, Contrast and Color Saturation;
e) Updating the said settings;
f) Repeat a through e.

18. The method as specified in claim 17 wherein said capture assembly 104 is made of one or two CCD video cameras pointed to said projection screen 100.

19. The method as specified in claim 17 wherein steps c), d) and e) are performed by a processor (AAVP system) 101.

20. The method as specified in claim 17 wherein the new value of projection Focus is computed proportionally to the measured distance between the said projection screen 100 and said projection lens 102.

21. The method as specified in claim 17 wherein the new value of projection Brightness is computed proportionally to the room Brightness measured from the capture of said projection screen 100 made by said capture assembly 104.

22. The method as specified in claim 17 wherein the new value of projection Contrast is function of the measured Contrast of the capture of said projection screen 100 made by said capture assembly 104.

23. The method as specified in claim 8 wherein the new value of projection Color Saturation is function of the measured color saturation of the capture of said projection screen 100 made by said capture assembly 104.
